(19) United States
(12) Patent Application Publication
(10) Pub. No.: US 2018/0277050 A1
(43) Pub. Date: Sep. 27, 2018

(54) GATE DRIVING CIRCUIT AND ARRAY SUBSTRATE USING THE SAME

(71) Applicant: SHENZHEN CHINA STAR OPTOELECTRONICS TECHNOLOGY CO. LTD., Shenzhen (CN)

(72) Inventor: Xiaoyu HUANG, Shenzhen (CN)

(21) Appl. No.: 14/906,584

(22) PCT Filed: Jan. 6, 2016
(86) PCT No.: PCT/CN2016/070289

§ 371 Date: Jan. 21, 2016

(30) Foreign Application Priority Data
Dec. 15, 2015 (CN) 201510939428.7

(51) Int. Cl. G09G 3/36

(52) U.S. Cl. CPC G09G 3/3677; G09G 2310/06; G09G 2310/0289

(57) ABSTRACT

A gate driving circuit and an array substrate using the same are described. The gate driving circuit comprises a scan driving circuit for outputting scan control signal; and a gate signal-processing module comprising a first switch unit and a second switch unit, for receiving the scan control signal wherein either when the gate signal-processing module receives the scan control signal having the first amplitude level, the gate signal-processing module enables the first switch unit and turns off the second switch unit for outputting first gate driving signal to a gate of a display region by the first switch unit, or when the gate signal-processing module receives the scan control signal having the second amplitude level, the gate signal-processing module enables the second switch unit and turns off the first switch unit for outputting second gate driving signal to the gate of the display region by the second switch unit.

### BACKGROUND OF THE INVENTION

### Field of Invention

The present invention relates to a technical field of a liquid crystal display (LCD), and more particularly to a gate driving circuit and an array substrate using the same.

### Description of Prior Art

Since the LCD is provided with the features of low radiation, small size and low power consumption for consumers, therefore, the conventional display unit with cathode ray tube is increasingly replaced by the LCD. An LCD panel is widely used in communication products including a notebook computer, a personal digital assistant (PDA), a flat panel television and mobile phone.

A thin film transistor (TFT) LCD is one of main flat panel display products, which has become a major display platform among the modern information technology products and video products. The driving principle of the LCD is that the system circuit board transmits R/G/B compressed signals, control signal and power signal to the connector of a printed circuit board (PCB) and the PCB is electrically connected to the display region of the LCD by way of a source-chip on film (S-COF) and a gate-chip on film (G-COF) to provide the LCD with the power and signals needed for operation.

With regard to the LCD's driving manner, the G-COF is able to implement an on/off control of the gates within the display region by outputting a high gate voltage (VGH) and a low gate voltage (VGL). With the increasing voltage difference between VGH and VGL, it is required to use more advanced semiconductor process to avoid the breakdown in the G-COF integrated circuit, thereby resulting in increased costs. Consequently, there is a need to develop a novel gate driving circuit to solve the problems of the conventional technique.

### SUMMARY OF THE INVENTION

Therefore, one objective of the present invention is to provide a gate driving circuit and an array substrate using the same by way of a gate signal-processing module so that the gate-chip on film (G-COF) is capable of generating a low control voltage to output a higher VGH and a lower VGL to the gates in order to prevent the G-COF integrated circuits breakdown, and thus there is no need to implement more advanced semiconductor process, thereby saving the manufacturing costs of the G-COF integrated circuits of the LCD.

Based on the above objective, the present invention sets forth a gate driving circuit according to a first embodiment of the present invention. The gate driving circuit which is disposed on an array substrate of a liquid crystal display (LCD) comprises a scan driving circuit, for outputting a scan control signal wherein the scan control signal comprises a first amplitude level and a second amplitude level which is less than the first amplitude level; and a gate signal-processing module electrically coupled to the scan driving circuit and comprising a first switch unit and a second switch unit, for receiving the scan control signal wherein either when the gate signal-processing module receives the scan control signal having the first amplitude level, the gate signal-processing module enables the first switch unit and turns off the second switch unit for outputting a first gate driving signal to a gate of a display region in the LCD by way of the first switch unit, or when the gate signal-processing module receives the scan control signal having the second amplitude level, the gate signal-processing module enables the second switch unit and turns off the first switch unit for outputting a second gate driving signal to the gate of the display region in the LCD by way of the second switch unit, and wherein a level difference between the first amplitude level and the second amplitude level is less than that between the first gate driving signal and the second gate driving signal.

In one embodiment, the first switch unit comprises a first transistor which is composed of a first source electrode, a first gate electrode and a first drain electrode.

In one embodiment, when the scan control signal triggers the first gate electrode using the first amplitude level, the first source electrode receives the first gate driving signal to allow the first drain electrode to output the first gate driving signal in order to drive the gate of the display region.

In one embodiment, the second switch unit comprises a second transistor which is composed of a second source electrode, a second gate electrode and a second drain electrode.

In one embodiment, when the scan control signal triggers the second gate electrode using the second amplitude level, the second source electrode receives the second gate driving signal to allow the second drain electrode to output the second gate driving signal in order to drive the gate of the display region.

In one embodiment, the first transistor comprises an opposite polarity in relation to the second transistor either for switching off the second transistor when the first transistor is switched on or for switching on the second transistor when the first transistor is switched off.

In one embodiment, the first gate driving signal is a gate activated voltage of the gate and the second gate driving signal is a gate inactivated voltage of the gate, and the gate signal-processing module is a circuit structure disposed in a gate-chip on film (G-COF) of the LCD.

In one embodiment, the first amplitude level and the second amplitude level of the scan control signal are less than the first gate driving signal and a level of the second gate driving signal is less than that of the first gate driving signal.

An array substrate according to a second embodiment of the present invention comprises a gate driving circuit disclosed in the above-mentioned descriptions.

In one embodiment of the array substrate, the first switch unit comprises a first transistor which is composed of a first source electrode, a first gate electrode and a first drain electrode.

In one embodiment of the array substrate, when the scan control signal triggers the first gate electrode using the first amplitude level, the first source electrode receives the first gate driving signal to allow the first drain electrode to output the first gate driving signal in order to drive the gate of the display region.

In one embodiment of the array substrate, the second switch unit comprises a second transistor which is composed of a second source electrode, a second gate electrode and a second drain electrode.

In one embodiment of the array substrate, when the scan control signal triggers the second gate electrode using the second amplitude level, the second source electrode receives the second gate driving signal to allow the second drain electrode to output the second gate driving signal in order to drive the gate of the display region.

In one embodiment of the array substrate, the first transistor comprises an opposite polarity in relation to the second transistor either for switching off the second transistor when the first transistor is switched on or for switching on the second transistor when the first transistor is switched off.

In one embodiment of the array substrate, the first gate driving signal is a gate activated voltage of the gate and the second gate driving signal is a gate inactivated voltage of the gate, and the gate signal-processing module is a circuit structure disposed in a gate-chip on film (G-COF) of the LCD.

In one embodiment of the array substrate, the first amplitude level and the second amplitude level of the scan control signal are less than the first gate driving signal and a level of the second gate driving signal is less than that of the first gate driving signal.

### BRIEF DESCRIPTION OF THE DRAWINGS

FIG. 1 is a schematic block diagram of a gate driving circuit according to one embodiment of the present invention;

FIG. 2 is a schematic view of an equivalent circuit of a gate signal-processing module in the gate driving circuit according to one embodiment of the present invention; and

FIG. 3 is a schematic waveform timing view of the gate signal-processing module according to one embodiment of the present invention.

### DETAILED DESCRIPTION OF THE PREFERRED EMBODIMENTS

The following embodiments refer to the accompanying drawings for exemplifying specific implementable embodiments of the present invention. Furthermore, directional terms described by the present invention, such as upper, lower, front, back, left, right, inner, outer, side, etc., are only directions by referring to the accompanying drawings, and thus the used directional terms are used to describe and understand the present invention, but the present invention is not limited thereto. In the drawings, the same reference symbol represents the same or a similar component.

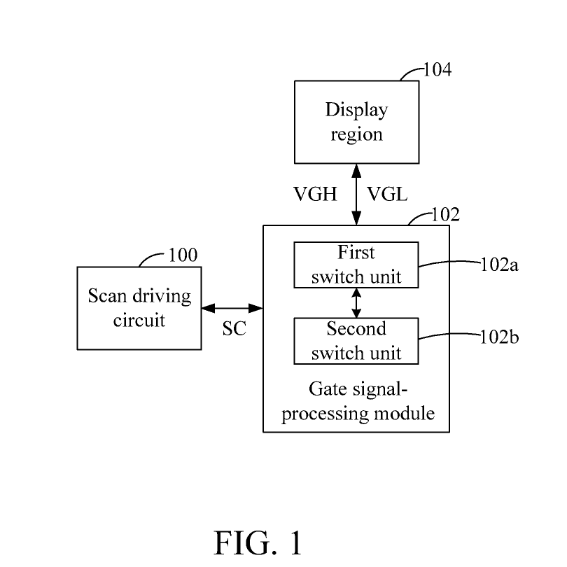

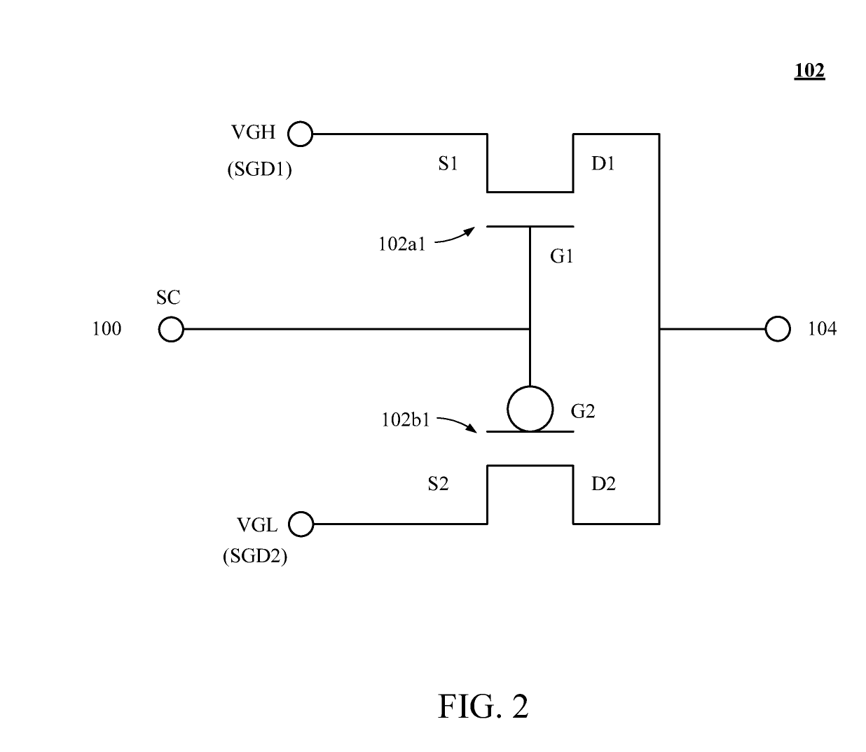

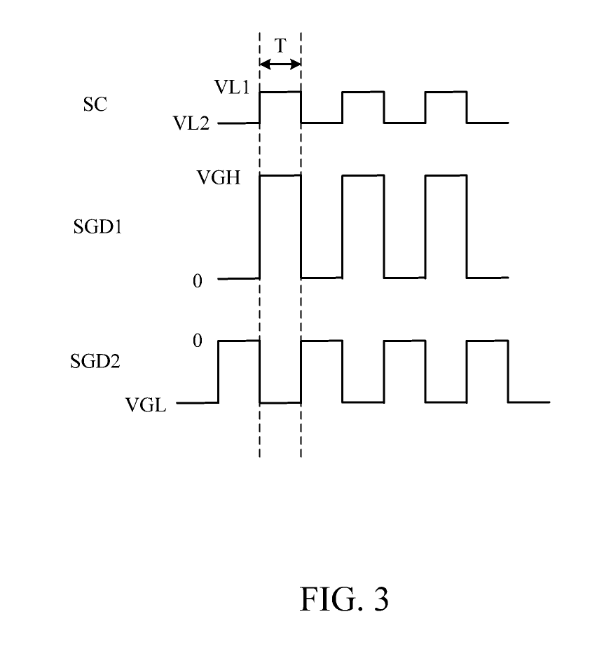

Please refer to FIGS. 1-3. FIG. 1 is a schematic block diagram of a gate driving circuit according to one embodiment of the present invention. FIG. 2 is a schematic view of an equivalent circuit of a gate signal-processing module in the gate driving circuit according to one embodiment of the present invention. FIG. 3 is a schematic waveform timing view of the gate signal-processing module according to one embodiment of the present invention. The gate driving circuit comprises a scan driving circuit 100 and gate signal-processing module 102 electrically coupled to the scan driving circuit 100. The gate driving circuit 102 is disposed on an array substrate 104 of a liquid crystal display (LCD) and the gate signal-processing module 102 is electrically coupled to the gates (not shown) of the display region 104 in the LCD. The scan driving circuit 102 is used to output a scan control signal SC wherein the scan control signal SC comprises a first amplitude level VL1 and a second amplitude level VL2 which is less than the first amplitude level VL1. In one embodiment, the first amplitude level VL1 has a high voltage, e.g. a positive voltage level 3.3V, but not limited, and the second amplitude level VL2 has a low voltage, e.g. 0V or a negative voltage, but not limited.

The gate signal-processing module 102 is electrically coupled to the scan driving circuit 100 and comprises a first switch unit 102a and a second switch unit 102b for receiving the scan control signal SC wherein either when the gate signal-processing module 102 receives the scan control signal SC having the first amplitude level VL1, the gate signal-processing module 102 enables the first switch unit 102a and turns off the second switch unit 102b for outputting a first gate driving signal SGD1 to a gate of a display region 104 in the LCD by way of the first switch unit 102a, or when the gate signal-processing module 102 receives the scan control signal SC having the second amplitude level VL2, the gate signal-processing module 102 enables the second switch unit 102b and turns off the first switch unit 102a for outputting a second gate driving signal SGD2 to the gate of the display region 104 in the LCD by way of the second switch unit 102b. Preferably, a level difference between the first amplitude level VL1 and the second amplitude level VL2 is less than that between the first gate driving signal SGD1 and the second gate driving signal SGD2. In other words, the first gate driving signal SGD1 and the second gate driving signal SGD2 are the voltage signals which are inputted to the gates in the display panel to drive the LCD. In one embodiment, the first gate driving signal SGD1 and the second gate driving signal SGD2 are generated by a driving voltage generation unit (not shown) wherein the driving voltage generation unit is electrically coupled to the first switch unit 102a and the second switch unit 102b respectively.

In one embodiment, the first switch unit 102a comprises a first transistor 102a1, e.g. a N-type TFT, which is composed of a first source electrode S1, a first gate electrode G1 and a first drain electrode D1. For example, when the scan control signal SC triggers the first gate electrode G1 using the first amplitude level VL1, the first source electrode 51 receives the first gate driving signal SGD1 to allow the first drain electrode D1 to output the first gate driving signal SGD1 in order to drive the gate of the display region 104.

In one embodiment, the second switch unit 102b comprises a second transistor 102b1, e.g. a P-type TFT, which is composed of a second source electrode S2, a second gate electrode G2 and a second drain electrode D2. For example, when the scan control signal SC triggers the second gate electrode G2 using the second amplitude level VL2, the second source electrode S2 receives the second gate driving signal SGD2 to allow the second drain electrode D2 to output the second gate driving signal SGD2 in order to drive the gate of the display region 104.

In one embodiment, the first transistor 102a1 comprises an opposite polarity in relation to the second transistor 102b1 either for switching off the second transistor 102b1 when the first transistor 102a1 is switched on or for switching on the second transistor 102b1 when the first transistor is switched off 102a1.

In one embodiment, the first gate driving signal SGD1 is a gate activated voltage, i.e. a high gate voltage (VGH), of the gate and the second gate driving signal SGD2 is a gate inactivated voltage, i.e. a low gate voltage (VGL), of the gate and the gate signal-processing module 102 is a circuit structure disposed in a gate-chip on film (G-COF) of the LCD.

In one embodiment, during a corresponding time interval T, the first amplitude level VL1 and the second amplitude level VL2 of the scan control signal SC are less than the first gate driving signal SGD1 and a level of the second gate driving signal SGD2 is less than that of the first gate driving signal SGD1 in order to prevent the G-COF integrated circuits breakdown, and thus there is no need to implement more advanced semiconductor process, thereby saving the manufacturing costs of the G-COF integrated circuits of the LCD.

The OLED display unit in the present invention adds a voltage regulation unit to the conventional driving circuit and regulates the voltage inputted to the OLED in real-time to avoid the driving voltage fluctuation so as to upgrade the uniformity of the display unit and increase the display effect.

An array substrate according to a second embodiment of the present invention comprises a gate driving circuit disclosed in the above-mentioned descriptions.

The gate driving circuit and an array substrate using the same in the present invention utilizes a gate signal-processing module so that the gate-chip on film (G-COF) is capable of generating a low control voltage to output a higher VGH and a lower VGL to the gates in order to prevent the G-COF integrated circuits breakdown, and thus there is no need to implement more advanced semiconductor process, thereby saving the manufacturing costs of the G-COF integrated circuits of the LCD.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

1. A gate driving circuit which is disposed on an array substrate of a liquid crystal display (LCD), the gate driving circuit comprising:
a scan driving circuit, for outputting a scan control signal wherein the scan control signal comprises a first amplitude level and a second amplitude level which is less than the first amplitude level; and
a gate signal-processing module electrically coupled to the scan driving circuit and comprising a first switch unit and a second switch unit, for receiving the scan control signal wherein either when the gate signal-processing module receives the scan control signal having the first amplitude level, the gate signal-processing module enables the first switch unit and turns off the second switch unit for outputting a first gate driving signal to a gate of a display region in the LCD by way of the first switch unit, or when the gate signal-processing module receives the scan control signal having the second amplitude level, the gate signal-processing module enables the second switch unit and turns off the first switch unit for outputting a second gate driving signal to the gate of the display region in the LCD by way of the second switch unit, and wherein a level difference between the first amplitude level and the second amplitude level is less than that between the first gate driving signal and the second gate driving signal.

2. The gate driving circuit of claim 1, wherein the first switch unit comprises a first transistor which is composed of a first source electrode, a first gate electrode and a first drain electrode.

3. The gate driving circuit of claim 2, wherein when the scan control signal triggers the first gate electrode using the first amplitude level, the first source electrode receives the first gate driving signal to allow the first drain electrode to output the first gate driving signal in order to drive the gate of the display region.

4. The gate driving circuit of claim 2, wherein the second switch unit comprises a second transistor which is composed of a second source electrode, a second gate electrode and a second drain electrode.

5. The gate driving circuit of claim 4, wherein when the scan control signal triggers the second gate electrode using the second amplitude level, the second source electrode receives the second gate driving signal to allow the second drain electrode to output the second gate driving signal in order to drive the gate of the display region.

6. The gate driving circuit of claim 4, wherein the first transistor comprises an opposite polarity in relation to the second transistor either for switching off the second transistor when the first transistor is switched on or for switching on the second transistor when the first transistor is switched off

7. The gate driving circuit of claim 1, wherein the first gate driving signal is a gate activated voltage of the gate and the second gate driving signal is a gate inactivated voltage of the gate, and the gate signal-processing module is a circuit structure disposed in a gate-chip on film (G-COF) of the LCD.

8. The gate driving circuit of claim 1, wherein the first amplitude level and the second amplitude level of the scan control signal are less than the first gate driving signal and a level of the second gate driving signal is less than that of the first gate driving signal.

9. An array substrate, comprising a gate driving circuit wherein the gate driving circuit comprises:
a scan driving circuit, for outputting a scan control signal wherein the scan control signal comprises a first amplitude level and a second amplitude level which is less than the first amplitude level; and
a gate signal-processing module electrically coupled to the scan driving circuit and comprising a first switch unit and a second switch unit, for receiving the scan control signal wherein either when the gate signal-processing module receives the scan control signal having the first amplitude level, the gate signal-processing module enables the first switch unit and turns off the second switch unit for outputting a first gate driving signal to a gate of a display region in the LCD by way of the first switch unit, or when the gate signal-processing module receives the scan control signal having the second amplitude level, the gate signal-processing module enables the second switch unit and turns off the first switch unit for outputting a second gate driving signal to the gate of the display region in the LCD by way of the second switch unit, and wherein a level difference between the first amplitude level and the second amplitude level is less than that between the first gate driving signal and the second gate driving signal.

10. The array substrate of claim 9, wherein the first switch unit comprises a first transistor which is composed of a first source electrode, a first gate electrode and a first drain electrode.

11. The array substrate of claim 10, wherein when the scan control signal triggers the first gate electrode using the first amplitude level, the first source electrode receives the first gate driving signal to allow the first drain electrode to output the first gate driving signal in order to drive the gate of the display region.

12. The array substrate of claim 10, wherein the second switch unit comprises a second transistor which is composed of a second source electrode, a second gate electrode and a second drain electrode.

13. The array substrate of claim 12, wherein when the scan control signal triggers the second gate electrode using the second amplitude level, the second source electrode receives the second gate driving signal to allow the second drain electrode to output the second gate driving signal in order to drive the gate of the display region.

14. The array substrate of claim 12, wherein the first transistor comprises an opposite polarity in relation to the second transistor either for switching off the second transistor when the first transistor is switched on or for switching on the second transistor when the first transistor is switched off.

15. The array substrate of claim 9, wherein the first gate driving signal is a gate activated voltage of the gate and the second gate driving signal is a gate inactivated voltage of the gate, and the gate signal-processing module is a circuit structure disposed in a gate-chip on film (G-COF) of the LCD.

16. The array substrate of claim 9, wherein the first amplitude level and the second amplitude level of the scan control signal are less than the first gate driving signal and a level of the second gate driving signal is less than that of the first gate driving signal.
